(19) United States
(12) Patent Application Publication
(10) Pub. No.: US 2026/0080712 A1
(43) Pub. Date: Mar. 19, 2026

(54) METHOD AND APPARATUS WITH FACIAL IMAGE LANDMARK DETECTION

(71) Applicant: SAMSUNG ELECTRONICS CO., LTD., Suwon-si (KR)

(72) Inventor: Hui LI, Xi'an (CN)

(73) Assignee: SAMSUNG ELECTRONICS CO., LTD., Suwon-si (KR)

(21) Appl. No.: 19/274,865

(22) Filed: Jul. 21, 2025

(30) Foreign Application Priority Data
Sep. 13, 2024 (CN) 202411289274.7
Feb. 24, 2025 (KR) 10-2025-0023860

(51) Int. Cl. G06V 40/16; G06V 10/77; G06V 10/82

(52) U.S. Cl. CPC G06V 40/168; G06V 10/7715; G06V 10/82

(57) ABSTRACT

A processor-implemented method including obtaining a multi-level feature map of a facial image through a convolutional neural network layer, generating an initial query matrix by fully connecting a feature map of a last level of the multi-level feature map through a fully connected layer, generating a memory feature matrix by flattening and concatenating the multi-level feature map, and determining, based on an input specifying at least one landmark style among a plurality of landmark styles, the memory feature matrix, and the initial query matrix, coordinates of a first landmark corresponding to the at least one landmark style of the facial image by using at least one decoder layer of one or more cascaded decoder layers.

### CROSS-REFERENCE TO RELATED APPLICATIONS

This application claims the benefit under 35 USC § 119(a) of Chinese Patent Application No. 202411289274.7 filed on Sep. 13, 2024, in the China National Intellectual Property Administration, and Korean Patent Application No. 10-2025-0023860 filed on Feb. 24, 2025, in the Korean Intellectual Property Office, the entire disclosures of which are incorporated herein by reference for all purposes.

### BACKGROUND

### 1. Field

The following description relates to a method and apparatus for detecting a landmark in a facial image.

### 2. Description of Related Art

The rapid advancement of a deep neural network in recent years has led to a remarkable development in technology for detecting a landmark in a facial image. Typical methods of detecting a landmark in a facial image include a heatmap regression-based method and a coordinate regression-based method.

The typical heatmap regression-based method may generate a heatmap based on the given landmark coordinates. In this case, each heatmap represents a probability of one landmark position, and a landmark may be obtained according to a position with the highest probability on a heatmap. The heatmap regression-based method may perform adequately because the spatial structure of an image feature may be retained.

The typical coordinate regression-based method may directly map an input image to landmark coordinates. An image feature may be obtained by inputting the input image to a convolutional neural network (CNN) model in a deep learning framework. The coordinate regression-based method may then map the image feature directly to the landmark coordinates through a fully connected prediction layer. Recently, a graph neural network and a transformer are used to learn a landmark structure in a facial image to improve detection accuracy.

However, the related arts may detect or predict only a single style or type of landmark through a single model. Time and memory are wasted to obtain different styles or types of landmarks because different models need to be trained. In addition, each dataset has a different annotation type, and thus, a model trained with one dataset is not applied appropriately to another dataset.

### SUMMARY

In a general aspect, here is provided a processor-implemented method including obtaining a multi-level feature map of a facial image through a convolutional neural network layer, generating an initial query matrix by fully connecting a feature map of a last level of the multi-level feature map through a fully connected layer, generating a memory feature matrix by flattening and concatenating the multi-level feature map, and determining, based on an input specifying at least one landmark style among a plurality of landmark styles, the memory feature matrix, and the initial query matrix, coordinates of a first landmark corresponding to the at least one landmark style of the facial image by using at least one decoder layer of one or more cascaded decoder layers.

Each of one or more cascaded decoder layers may include a cascaded mask processing element, a self-attention processing element, a transformable attention processing element, and a landmark coordinate prediction model and the determining of the coordinates of the first landmark may include generating, based on the at least one landmark style specified by the input among the plurality of landmark styles, a mask matrix corresponding to the at least one landmark style, and, masking, based on the mask matrix, a query matrix, a key matrix, and a value matrix being input to the self-attention processing element to predict the coordinates of the first landmark.

The determining of the coordinates of the first landmark may include masking, based on the mask matrix, the initial query matrix and position information corresponding to the initial query matrix by using a first mask processing element of a first decoder layer and setting a subset of elements of the initial query matrix and the position information to 0, inputting the initial query matrix after masking to which the position information after masking is embedded to a self-attention processing element of the first decoder layer as a query matrix and a key matrix of the self-attention processing element of the first decoder layer and inputting the initial query matrix after masking to the self-attention processing element of the first decoder layer as a value matrix of the self-attention processing element of the first decoder layer, generating, by inputting an output matrix of a self-attention processing element of a current decoder layer, the memory feature matrix, and the coordinates of the first landmark predicted by a previous decoder layer after masking to a transformable attention processing element of the current decoder layer, an output matrix of the transformable attention processing element of the current decoder layer, by masking the output matrix of the transformable attention processing element of the current decoder layer and position information corresponding to the output matrix of the transformable attention processing element of the current decoder layer, based on the mask matrix, by using a mask processing element of a next decoder layer of the current decoder layer, setting a subset of elements of the output matrix of the transformable attention processing element of the current decoder layer and the position information of the output matrix of the transformable attention processing element of the current decoder layer to 0, inputting, as a value matrix, a query matrix, and a key matrix of a self-attention processing element of the next decoder layer, the output matrix of the transformable attention processing element of the current decoder layer after masking, an output matrix of the transformable attention processing element of the current decoder layer after masking to which the position information after masking is embedded, and an output matrix of the transformable attention processing element of the current decoder layer after masking to which the position information after masking is embedded to the self-attention processing element of the next decoder layer, generating, by inputting the output matrix of the transformable attention processing element of the current decoder layer and the coordinates of the first landmark predicted by the previous decoder layer after masking to a landmark coordinate prediction processing element of the current decoder layer, the coordinates of the first landmark predicted by the current decoder layer, and setting the coordinates of the first landmark predicted by a last decoder layer of the one or more cascaded decoder layers to final coordinates of the first landmark.

A first number of elements of the initial query matrix may be a sum of a second number of landmarks corresponding to each landmark style among the plurality of landmark styles.

The subset of elements may correspond to landmarks excluding the first landmark among landmarks corresponding to the plurality of landmark styles.

The output matrix of the transformable attention processing element of the current decoder layer and the memory feature matrix may include a query matrix and a value matrix of the transformable attention processing element of the current decoder layer and the coordinates of the first landmark predicted by the previous decoder layer after masking, which is input to a transformable attention processing element of the first decoder layer, may include landmark coordinates obtained by masking, based on the mask matrix, initial landmark coordinates obtained based on the initial query matrix, the coordinates of the first landmark predicted by the previous decoder layer after masking may be obtained by setting a subset of elements of the coordinates of the first landmark predicted by the previous decoder layer based on the mask matrix of the mask processing element.

An output matrix QE of a self-attention processing element of each of one or more cascaded decoder layers may be obtained through an first equation of

$${q}_{i}^{E} = {\sum }_{j = 1}^{N} {α}_{ij} {q}_{j} , i = 1 , 2 , … N$$

and

$${q}_{i}^{E}$$

denotes an i^{th} row vector of the output matrix QE, aᵢⱼ denotes an attention weight obtained by normalizing an inner product between an i^{th} row vector of a query matrix input to the self-attention processing element and a j^{th} row vector of a key matrix input to the self-attention processing element, and qⱼ denotes a j^{th} row vector of an initial query matrix after masking or an output matrix of a transformable attention processing element of the previous decoder layer after masking.

An output matrix QD of a transformable attention processing element of each of the one or more cascaded decoder layers may be obtained through a second equation of

$${f}_{i} = {\sum }_{k = 1}^{K} {β}_{ik} {x}_{ik} , i = 1 , … , N$$

and, fᵢ denotes an updated feature of an i^{th} landmark of the output matrix QD, βᵢₖ denotes an attention weight obtained by performing a full connection operation and a SoftMax operation on a query matrix input to the transformable attention processing element, and xᵢₖ denotes a feature corresponding to k^{th} reference point coordinates in the memory feature matrix, and a position offset between the k^{th} reference point coordinates and i^{th} landmark coordinates of the coordinates of the first landmark predicted by the previous decoder layer after masking may be obtained by performing a full connection operation on the query matrix input to the transformable attention processing element, and k is a preset value.

The coordinates of the first landmark predicted by each of the one or more cascaded decoder layers may be obtained through a third equation of y=σ(y_{O}+σ⁻¹(y_{R})) and y denotes the coordinates of the first landmark predicted by the current decoder layer, y_{R} denotes the coordinates of the first landmark predicted by the previous decoder layer after masking, and y_{O} denotes an offset of y for y_{R}.

In a general aspect, here is provided an electronic apparatus including an encoder, the encoder being configured to obtain a multi-level feature map of a facial image through a convolutional neural network layer, generate an initial query matrix by fully connecting a feature map of a last level of the multi-level feature map through a fully connected layer, and generate a memory feature matrix by flattening and concatenating the multi-level feature map and a decoder, the decoder being configured to determine, based on an input specifying at least one landmark style among a plurality of landmark styles, the memory feature matrix, and the initial query matrix, coordinates of a first landmark corresponding to the at least one landmark style of the facial image by using at least one decoder layer of one or more cascaded decoder layers.

Each of the one or more cascaded decoder layers may include a cascaded mask processing element, a self-attention processing element, a transformable attention processing element, and a landmark coordinate prediction model and the decoder, based on the at least one landmark style specified by the input among the plurality of landmark styles, may be configured to generate a mask matrix corresponding to the at least one landmark, and, to mask, based on the mask matrix, a query matrix, a key matrix, and a value matrix being input to the self-attention processing element to predict the coordinates of the first landmark.

The decoder may be further configured to mask, based on the mask matrix, the initial query matrix and position information corresponding to the initial query matrix by using a mask processing element of a first decoder layer and sets a subset of elements of the initial query matrix and the position information to 0, input the initial query matrix after masking to which the position information after masking is embedded to the self-attention processing element of the first decoder layer as a query matrix and a key matrix of a self-attention processing element of the first decoder layer and inputs the initial query matrix after masking to the self-attention processing element of the first decoder layer as a value matrix of the self-attention processing element of the first decoder layer, generate, by inputting an output matrix of a self-attention processing element of a current decoder layer, the memory feature matrix, and the coordinates of the first landmark predicted by a previous decoder layer after masking to a transformable attention processing element of the current decoder layer, an output matrix of the transformable attention processing element of the current decoder layer, and by masking the output matrix of the transformable attention processing element of the current decoder layer and position information corresponding to the output matrix of the transformable attention processing element of the current decoder layer, based on the mask matrix, by using a mask processing element of a next decoder layer of the current decoder layer, a subset of elements of the output matrix of the transformable attention processing element of the current decoder layer and the position information of the output matrix of the transformable attention processing element of the current decoder layer to 0.

A first number of elements of the initial query matrix may be a sum of a second number of landmarks corresponding to each landmark style among the plurality of landmark styles.

The subset of elements may correspond to landmarks excluding the first landmark among landmarks corresponding to the plurality of landmark styles.

The decoder is further may be configured to input, as a value matrix, a query matrix, and a key matrix of a self-attention processing element of the next decoder layer, the output matrix of the transformable attention processing element of the current decoder layer after masking and an output matrix of the transformable attention processing element of the current decoder layer after masking to which the position information after masking is embedded, and an output matrix of the transformable attention processing element of the current decoder layer after masking to which the position information after masking is embedded to the self-attention processing element of the next decoder layer, generate, by inputting the output matrix of the transformable attention processing element of the current decoder layer and the coordinates of the first landmark predicted by the previous decoder layer after masking to a landmark coordinate prediction processing element of the current decoder layer, the coordinates of the first landmark predicted by the current decoder layer, and set the coordinates of the first landmark predicted by a last decoder layer of the one or more cascaded decoder layers to final coordinates of the first landmark.

The output matrix of the transformable attention processing element of the current decoder layer and the memory feature matrix may be a query matrix and a value matrix of the transformable attention processing element of the current decoder layer, the coordinates of the first landmark predicted by the previous decoder layer after masking, which is input to a transformable attention processing element of the first decoder layer, may be landmark coordinates obtained by masking, based on the mask matrix, initial landmark coordinates obtained based on the initial query matrix, and the coordinates of the first landmark may be predicted by the previous decoder layer after masking are obtained by setting a subset of elements of the coordinates of the first landmark predicted by the previous decoder layer based on the mask matrix of the mask processing element.

An output matrix QE of a self-attention processing element of each of the at least one decoder layer may be obtained through a first equation of

$${q}_{i}^{E} = {\sum }_{j = 1}^{N} {α}_{ij} {q}_{j} , i = 1 , 2 , … N and {q}_{i}^{E}$$

denotes an i^{th} row vector of the output matrix QE, aᵢⱼ denotes an attention weight obtained by normalizing an inner product between an i^{th} row vector of a query matrix input to the self-attention processing element and a j^{th} row vector of a key matrix input to the self-attention processing element, and qⱼ denotes a j^{th} throw vector of an initial query matrix after masking or an output matrix of a transformable attention processing element of the previous decoder layer after masking.

An output matrix QD of a transformable attention processing element of each of the at least one decoder layer may be obtained through a second equation of

$${f}_{i} = {\sum }_{k = 1}^{K} {β}_{ik} {x}_{ik} , i = 1 , … , N$$

and denotes an updated feature of an i^{th} landmark of the output matrix QD, βᵢₖ denotes an attention weight obtained by performing a full connection operation and a SoftMax operation on a query matrix input to the transformable attention processing element, and xᵢₖ denotes a feature corresponding to k^{th} reference point coordinates in the memory feature matrix, and a position offset between the k^{th} reference point coordinates and i^{th} landmark coordinates of the coordinates of the first landmark predicted by the previous decoder layer after masking is obtained by performing a full connection operation on the query matrix input to the transformable attention processing element, and k is a preset value.

The coordinates of the first landmark may be predicted by each of the at least one decoder layer are obtained through a third equation of y=σ(y_{O}+σ⁻¹(y_{R})), and y denotes the coordinates of the first landmark predicted by the current decoder layer, y_{R} denotes the coordinates of the first landmark predicted by the previous decoder layer after masking, and y_{O} denotes an offset of y for y_{R}.

In a general aspect, here is provided an electronic device including processors configured to execute instructions, a memory storing the instructions, and an execution of the instructions configures the processors to obtain a multi-level feature map of a facial image through a convolutional neural network layer, generate an initial query matrix by fully connecting a feature map of a last level of the multi-level feature map through a fully connected layer, generate a memory feature matrix by flattening and concatenating the multi-level feature map, and, determine, based on an input specifying at least one landmark style among a plurality of landmark styles, the memory feature matrix, and the initial query matrix, coordinates of a first landmark corresponding to the at least one landmark style of the facial image by using at least one decoder layer of one or more cascaded decoder layers.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 illustrates example landmark styles for predicting facial landmark coordinates according to one or more embodiments.

FIG. 2 illustrates an example electronic apparatus with facial image landmark detection according to one or more embodiments.

FIG. 3 illustrates an example decoder for the facial image landmark detection device according to one or more embodiments.

FIG. 4 illustrates an example method with facial image landmark detection according to one or more embodiments.

FIG. 5 illustrates an example first decoder layer according to one or more embodiments.

FIG. 6 illustrates an example device with landmark coordinate prediction of a facial image according to one or more embodiments.

FIG. 7 illustrates an electronic device with landmark coordinate prediction of a facial image according to one or more embodiments.

FIG. 8 illustrates an electronic device in a network environment according to one or more embodiments.

Throughout the drawings and the detailed description, unless otherwise described or provided, the same, or like, drawing reference numerals may be understood to refer to the same, or like, elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences within and/or of operations described herein are merely examples, and are not limited to those set forth herein, but may be changed as will be apparent after an understanding of the disclosure of this application, except for sequences within and/or of operations necessarily occurring in a certain order. As another example, the sequences of and/or within operations may be performed in parallel, except for at least a portion of sequences of and/or within operations necessarily occurring in an order, e.g., a certain order. Also, descriptions of features that are known after an understanding of the disclosure of this application may be omitted for increased clarity and conciseness.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application. The use of the term “may” herein with respect to an example or embodiment (e.g., as to what an example or embodiment may include or implement) means that at least one example or embodiment exists where such a feature is included or implemented, while all examples are not limited thereto. The use of the terms “example”, “embodiment”, and “example embodiment” herein have a same meaning (e.g., the phrasing ‘in an or one example’ has a same meaning as ‘in an or one embodiment” and ‘in an or one example embodiment’), and “one or more examples” has a same meaning as “one or more embodiments” and “one or more example embodiments”. Still further, each of multiple or all separately described an/one “example”, “embodiment”, “example embodiment”, as well as “examples”, “embodiments”, “example embodiments”, herein may be included, in combination, in a same embodiment in any combination.

Although terms such as “first,” “second,” and “third”, or A, B, (a), (b), and the like may be used herein to describe various members, components, regions, layers, or sections, these members, components, regions, layers, or sections are not to be limited by these terms. Each of these terminologies is not used to define an essence, order, or sequence of corresponding members, components, regions, layers, or sections, for example, but used merely to distinguish the corresponding members, components, regions, layers, or sections from other members, components, regions, layers, or sections. Thus, a first member, component, region, layer, or section referred to in the examples described herein may also be referred to as a second member, component, region, layer, or section without departing from the teachings of the examples.

The terminology used herein is for describing various examples only and is not to be used to limit the disclosure. The articles “a,” “an,” and “the” are intended to include the plural forms as well, unless the context clearly indicates otherwise. As non-limiting examples, terms “comprise” or “comprises,” “include” or “includes,” and “have” or “has” specify the presence of stated features, numbers, operations, members, elements, and/or combinations thereof, but do not preclude the presence or addition of one or more other features, numbers, operations, members, elements, and/or combinations thereof, or the alternate presence of an alternative stated features, numbers, operations, members, elements, and/or combinations thereof. Additionally, while one embodiment may set forth such terms “comprise” or “comprises,” “include” or “includes,” and “have” or “has” specify the presence of stated features, numbers, operations, members, elements, and/or combinations thereof, other embodiments may exist where one or more of the stated features, numbers, operations, members, elements, and/or combinations thereof are not present.

As used in connection with various example embodiments of the disclosure, any use of the terms “module” or “unit” means hardware and/or processing hardware configured to implement software and/or firmware to configure such processing hardware to perform corresponding operations, and may interchangeably be used with other terms, for example, “logic,” “logic block,” “part,” or “circuitry”. As one non-limiting example, an application-predetermined integrated circuit (ASIC) may be referred to as an application-predetermined integrated module. As another non-limiting example, a field-programmable gate array (FPGA) or an application-specific integrated circuit (ASIC) may be respectively referred to as a field-programmable gate unit or an application-specific integrated unit. In a non-limiting example, such software may include components such as software components, object-oriented software components, class components, and may include processor task components, processes, functions, attributes, procedures, subroutines, segments of the software. Software may further include program code, drivers, firmware, microcode, circuits, data, database, data structures, tables, arrays, and variables. In another non-limiting example, such software may be executed by one or more central processing units (CPUs) of an electronic device or secure multimedia card.

Unless otherwise defined, all terms, including technical and scientific terms, used herein have the same meaning as commonly understood by one of ordinary skill in the art to which this disclosure pertains and specifically in the context on an understanding of the disclosure of the present application. Terms, such as those defined in commonly used dictionaries, are to be interpreted as having a meaning that is consistent with their meaning in the context of the relevant art and specifically in the context of the disclosure of the present application, and are not to be interpreted in an idealized or overly formal sense unless expressly so defined herein.

Landmark detection may be planned as a problem of detecting or predicting N coordinates. Here, N denotes the number of facial landmarks.

The style or type of landmarks of the present disclosure may indicate how many landmarks are used to annotate a facial image and where the landmarks are annotated in the facial image.

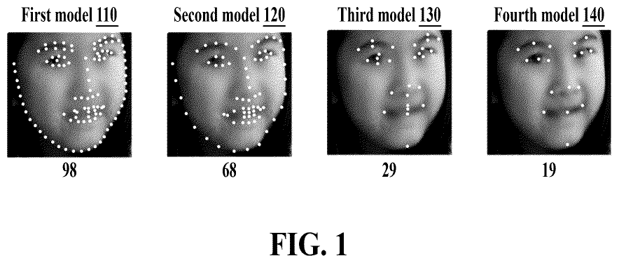

Hereinafter, a method and apparatus for detecting a landmark in a facial image, according to an embodiment of the present invention, are described below with reference to FIGS. 1 to 8.

FIG. 1 illustrates example landmark styles for predicting facial landmark coordinates according to one or more embodiments.

Referring to FIG. 1, in a non-limiting example, a first model 110, a second model 120, a third model 130, and a fourth model 140 are compared. In the illustrated comparison, each model is shown with the number of landmarks they may detect. For example, the first model 110 may detect 98 landmarks, the second model 120 may detect 68 landmarks, the third model 130 may detect 29 landmarks, and the fourth h40 may detect 19 landmarks.

In typical related methods, a landmark prediction model may predict only one style or type of landmark. For example, the first model 110 may detect only 98 landmarks, and the second model 120 may detect only 68 landmarks. Therefore, to detect all the 98 and 68 landmarks, the first model 120 and the second model 120 may need to be trained separately.

In an example, a method and apparatus for detecting a landmark of a facial image of the present disclosure may detect various types or styles of landmarks in a facial image through a single model.

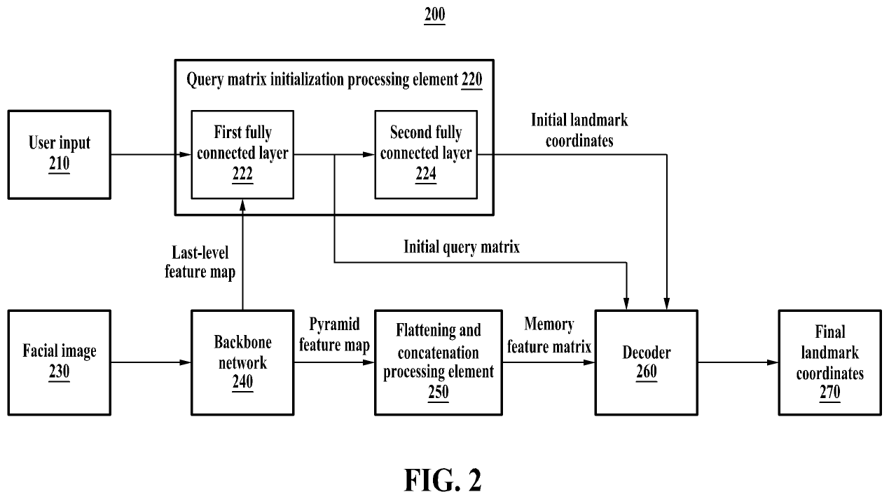

FIG. 2 illustrates an example electronic apparatus with facial image landmark detection according to one or more embodiments.

Referring to FIG. 2, in a non-limiting example, an electronic apparatus 200 with facial image landmark detection may include a backbone network 240, a query matrix initialization processing element 220, a flattening and concatenation flattening and concatenation processing element 250 250, and a decoder 260.

In an example, the backbone network 240 may obtain a pyramid feature of a facial image and may obtain feature maps of various sizes at each level.

In an example, the query matrix initialization processing element 220 may include a first fully connected layer 222 and a second fully connected layer 224.

The first fully connected layer 222 may obtain an initial query matrix by fully connecting a last-level feature map (i.e., a last-level feature or a top-level feature of the pyramid feature) of a multi-level feature map.

The second fully connected layer 224 may fully connect the initial query matrix to obtain initial landmark coordinates.

In an example, the flattening and concatenation processing element 250 may obtain a memory feature matrix by flattening and concatenating the multi-level feature map.

In an example, the decoder 260 may, by using the memory feature matrix, the initial query matrix, and the initial landmark coordinates, determine the coordinates of a first landmark corresponding to at least one landmark style of a facial image for a landmark style specified by a user input 210.

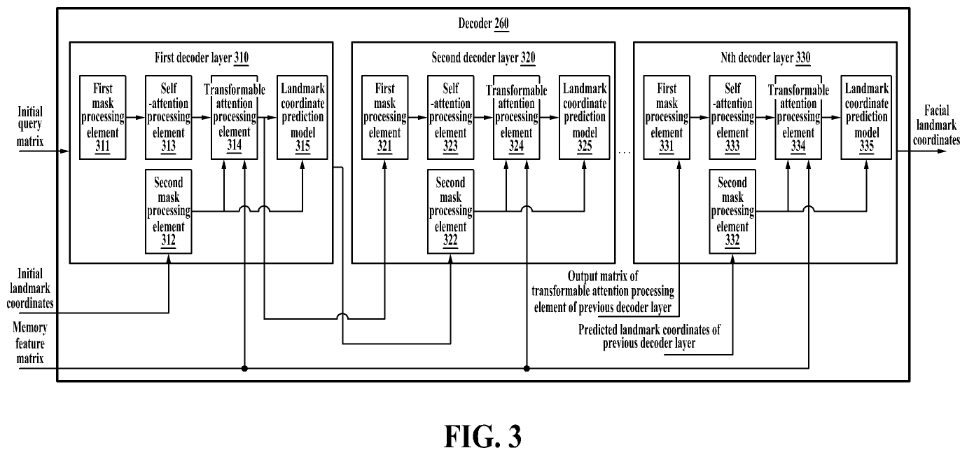

FIG. 3 illustrates an example decoder for the facial image landmark detection device according to one or more embodiments.

Referring to FIG. 3, in a non-limiting example, the decoder 260 may include a plurality of cascaded decoder layers 310, 320, 330.

Each decoder layer 310, 320, 330 may include a cascaded first mask processing element 311, 321, 331, a self-attention processing element 313, 323, 333, a transformable attention processing element 314, 324, 334, a landmark coordinate prediction model 315, 325, 335, and a second mask processing element 312, 322, 332.

Nonetheless, although the first mask processing element 311, 321, 331 and the second mask processing element 312, 322, 332 are illustrated in each decoder layer 310, 320, 330 of FIG. 3, this is merely an example, and the present disclosure is not limited thereto.

For example, each decoder layer 310, 320, 330 may include only one mask processing element, which may perform masking on an output matrix (in which the output matrix of a transformable attention processing element of a previous decoder layer of a first decoder layer 310 is an initial query matrix) of a transformable attention processing element of a previous decoder layer of a current decoder layer and an output matrix (in which the output matrix of the previous decoder layer of the first decoder layer 310 is initial landmark coordinates) of the previous decoder layer.

In another example, each decoder layer 310, 320, 330 may include three mask processing element, which may be interlinked respectively to the self-attention processing element 313, 323, 333, the transformable attention processing element 314, 324, 334 and the landmark coordinate prediction model 315, 325, 335 of the decoder layer 310, 320, 330. For example, a first mask processing element may mask a query matrix, a key matrix, and a value matrix that are input to a self-attention processing element of the current decoder layer. A second mask processing element may mask an output matrix (in which the output matrix of a landmark coordinate prediction model of a previous decoder layer of a first decoder layer is the initial landmark coordinates) of a landmark coordinate prediction model of the previous decoder layer, and the output matrix after masking may be input to a transformable attention processing element of the current decoder layer. A third mask processing element may also mask the output matrix of the landmark coordinate prediction model of the previous decoder layer, and the output matrix after masking may be input to a landmark coordinate prediction model of the current decoder layer.

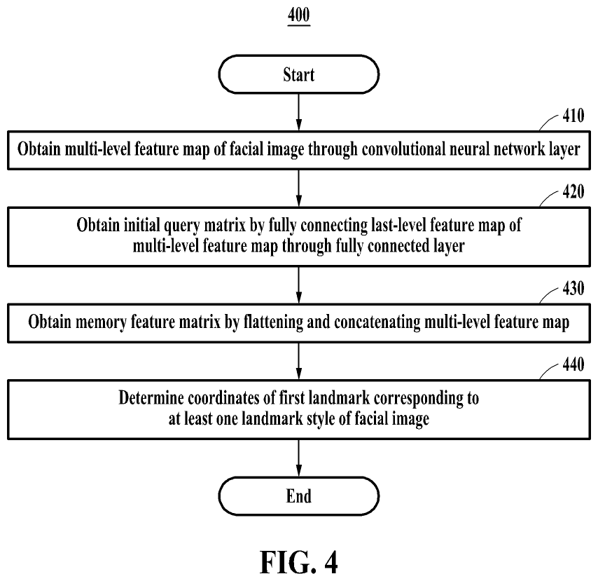

FIG. 4 illustrates an example method with facial image landmark detection according to one or more embodiments.

Referring to FIG. 4, in a non-limiting example, method 400 may detect a landmark in a facial image and may include operations 410, 420, 430, and 440 where operation 410 may, through an electronic apparatus such as electronic apparatus 200 of FIG. 2, obtain a multi-level feature map (e.g., the feature maps of four models in FIG. 1) of the facial image through a convolutional neural network layer. In an example, an extracted multi-level feature map may be a pyramid feature map, in which a low-level feature map represents a local feature of an image, and a high-level feature map may represent a global feature of the image.

For example, the method 400 may obtain a pyramid feature of the facial image through a backbone network and may obtain feature maps of various sizes at each level. In this disclosure, the backbone network uses ResNet 18, but examples are not limited thereto. For example, the backbone network may use at least one of ResNet-34, ResNet-50, vgg, or mobileNet.

For example, when the size of a given input image is 256×256×3, the respective sizes of feature maps at each level may be 64×64×64, 32×32×128, 16×16×256, and 8×8×512.

In an example, in operation 420, the method 400 may, through the electronic device (e.g., electronic device 200), obtain an initial query matrix Qᵢₙₜ by fully connecting a last-level feature map (i.e., a last-level feature or a top-level feature of the pyramid feature) of the multi-level feature map through a fully connected layer. In this case, an initial query matrix may represent an initial feature for a landmark in the facial image.

In an example, in operation 430, the method 400 may, through the electronic device (e.g., electronic device 200), obtain a memory feature matrix by flattening and concatenating the multi-level feature map. Specifically, in method 400, after extracting a pyramid feature from an input image by using the backbone network, a 1×1 convolution may be applied to such a feature map to obtain a feature map having the same number of output channels. This feature map may then be flattened and concatenated to be used as a memory feature matrix M.

In an example, in operation 440, the method 400 may, through the electronic device (e.g., electronic device 200), determine the coordinates of a first landmark corresponding to at least one landmark style of the facial image by using at least one decoder layer of one or more decoder layers that are cascaded (i.e., at least one cascaded decoder layer), based on a user input to specify at least one landmark style among a plurality of landmark styles, the memory feature matrix, and the initial query matrix.

For example, each of the at least one decoder layer may include a cascaded mask model, a self-attention model, a transformable attention model, and a landmark coordinate prediction block.

In this case, in operation 440 a mask matrix may be obtained corresponding to at least one landmark based on the at least one landmark style among the plurality of landmark styles specified (or requested) by the user input and may mask a query matrix, a key matrix, and a value matrix that are input to a self-attention model based on the mask matrix to predict the coordinates of the first landmark. For example, the first landmark may include a plurality of landmarks.

For example, when a user specifies that 98 landmark styles are required or requested, the at least one cascaded decoder layer may determine the coordinates of 98 points at specific positions in the facial image.

For example, when the user specifies or requests 98 landmark styles in addition to 19 landmark styles, the at least one cascaded decoder layer may determine the coordinates of 98 points at their respective specific positions in the facial image and the coordinates of 19 landmarks at their respective specific positions.

For example, the number of elements in the initial query matrix may be N, in which N represents the sum of the number of landmarks corresponding to each landmark style among the plurality of landmark styles.

For example, when a prediction model is trained to detect any one of and/or a combination of 19, 29, and 68 landmark types, the value of N may be 116.

For example, the initial query matrix Qᵢₙᵢₜ may be obtained as shown in Equation 1 below.

$${Q}_{init} = FC ( F ) \qquad Equation 1$$

Here, the symbol F denotes a feature map of the last layer of the backbone network, and its size may be expressed by (H×W)×C, in which H and W denote the spatial width and height of the feature map, respectively, and C denotes a feature dimension of the feature map. FC denotes a fully connected layer, and the spatial size of each feature channel (H× W) may be mapped to a vector of a size N.

The size of the initial query matrix Qᵢₙᵢₜ may be N×C, in which N denotes the number of landmarks in the facial image, and C denotes the feature dimension. This matrix is trainable and may be used to extract features associated with landmarks and transform them into coordinates.

In an example, each decoder layer may have the same structure, but only an input matrix and an output matrix of each decoder layer may be different.

For example, each decoder layer may include a cascaded mask model, a self-attention model, a transformable attention model, and a landmark coordinate prediction model. However, each decoder layer may include additional models, units, or layers as needed.

For example, in operation 440, the method 400 may, by using a mask model of a first decoder layer based on the mask matrix, mask the initial query matrix and the position information of the initial query matrix and may set some elements (i.e., a subset of these elements) of the initial query matrix and the position information to 0. That is, the subset of elements may be less than all or every element of the initial query matrix. In this case, these set elements may correspond to other landmarks among landmarks of the plurality of landmark styles, excluding the first landmark. For example, the position information is position information for performing position embedding on a query matrix.

In an example, in operation 440, the method 400 may perform a masking operation by using a mask matrix Qₘₐₛₖ.

For example, the mask matrix may be a variable matrix of the size N. In this case, the value of each element of an initial mask matrix may be 0. The method 400 may, based on the user input, set the value of an element corresponding to a landmark of a landmark style specified by the user to 1 and may set the remaining elements to 0.

In an example, the method 400 may generate a position embedding of a length N for the mask matrix.

For example, when N=n₁+n₂+n₃+ . . . +nᵢ, n₁, n₂, n₃, . . . , nᵢ denote the number of points of each landmark style annotation. When the user requests to detect a style 2 (e.g., 68 points) specifically, the method 400 may set elements at positions corresponding to n₂ landmarks to 1 and may set the remaining elements to 0.

For example, when N=214 (i.e., 98+68+29+19), the method 400 may detect landmarks of landmark styles of four models. In other words, N elements of the initial mask matrix may all be 0. When the user specifies to output the style 2 (a 68-point landmark detection result), the method 400 may set elements at positions of 167(99+68) from 99 of the mask matrix Qₘₐₛₖ to 1 and may maintain the remaining positions as 0.

For example, when Q is a feature of N*C, and Qₘₐₛₖ is an N-dimensional vector, in which some elements are 1 and some elements are 0, the method 400, when performing Q*Qₘₐₛₖ, may set an element corresponding to an element, in which Qₘₐₛₖ is 0 in Q, to 0 and may obtain a masked Q.

For example, in operation 440, the method 400 may input the initial query matrix after masking to which the position information after masking is embedded, the initial query matrix after masking to which the position information after masking is embedded, and the initial query matrix after masking to the self-attention model of the first decoder layer, respectively as a query matrix, a key matrix, and a value matrix of a self-attention model of the first decoder layer, to the self-attention model of the first decoder layer.

For example, in operation 440, the method 400 may, by inputting an output matrix of a self-attention model of a current decoder layer, the memory feature matrix, and the coordinates of the first landmark predicted by a previous decoder layer after masking to a transformable attention model of the current decoder layer, obtain an output matrix of the transformable attention model of the current decoder layer. In this case, the output matrix of the transformable attention model of the current decoder layer and the memory feature matrix may be a query matrix and a value matrix of the transformable attention model of the current decoder layer. In addition, the coordinates of the first landmark predicted by the previous decoder layer after masking, which is input to a transformable attention model of the first decoder layer, may be landmark coordinates obtained by masking, based on the mask matrix, initial landmark coordinates obtained based on the initial query matrix. In this case, the coordinates of the first landmark predicted by the previous decoder layer after masking may be obtained by setting some elements (i.e., set elements) of the coordinates of the first landmark predicted by the previous decoder layer based on the mask matrix of the mask model. In this case, those set elements may correspond to landmarks, excluding the first landmark, among landmarks of the plurality of landmark styles.

For example, the method 400 may obtain the initial landmark coordinates by fully connecting the query matrix.

For example, in operation 440, the method 400 may, by masking the output matrix of the transformable attention model of the current decoder layer and position information corresponding to the output matrix of the transformable attention model of the current decoder layer, based on the mask matrix, by using a mask model of a next decoder layer of the current decoder layer, set some elements of the output matrix of the transformable attention model of the current decoder layer and the position information of the output matrix of the transformable attention model of the current decoder layer to 0. In this case, those set elements may correspond to landmarks, excluding the first landmark, among landmarks of the plurality of landmark styles. The masking is similar to the performing of the masking described above, and any repeated descriptions thereof are omitted herein.

In addition, in operation 440, the method 400 may, as a value matrix, a query matrix, and a key matrix of a self-attention model of the next decoder layer, input the output matrix of the transformable attention model of the current decoder layer after masking, the output matrix of the transformable attention model of the current decoder layer after masking to which the position information after masking is embedded, and the output matrix of the transformable attention model of the current decoder layer after masking to which the position information after masking is embedded to the self-attention model of the next decoder layer. In addition, the method 400 may, by inputting the output matrix of the transformable attention model of the current decoder layer and the coordinates of the first landmark predicted by the previous decoder layer after masking to a landmark coordinate prediction model of the current decoder layer, obtain the coordinates of the first landmark predicted by the current decoder layer. In this case, the coordinates of the first landmark predicted by a last decoder layer of the at least one decoder layer may be set to final coordinates of the first landmark.

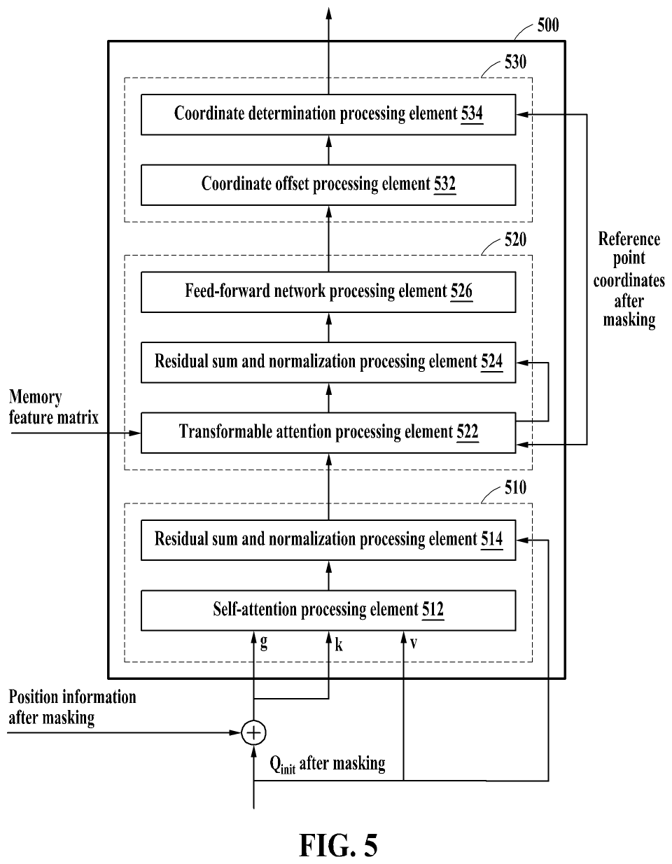

FIG. 5 illustrates an example first decoder layer according to one or more embodiments.

Although FIG. 5 illustrates an example structure of the first decoder layer, another decoder layer (e.g., the second decoder layer) may have the same structure.

While the mask model is not illustrated in FIG. 5, its absence should not limit examples of the masking. For example, position information after masking, an initial query matrix Qᵢₙᵢₜ after masking, and reference point coordinates after masking may all be obtained by performing masking on position information, the initial query matrix Qᵢₙᵢₜ, and reference point coordinates (i.e., the coordinates of a first landmark predicted by a previous decoder or an output (initial landmark coordinates in the case of the first decoder) of a previous decoder layer) through a mask processing element. The masking is described in detail above, and thus, a self-attention processing element 510 and a transformable attention processing element 520 included in a decoder layer 500 are mainly described below.

Referring to FIG. 5, in a non-limiting example, the decoder layer 500 may include the self-attention processing element 510, the transformable attention processing element 520, and a landmark coordinate prediction model 530. The self-attention processing element 510 of the decoder layer 500 may include a self-attention processing element 512 and a residual sum and normalization (Add&Norm) processing element 514.

The transformable attention processing element 520 of the decoder layer 500 may include a transformable attention processing element 522, a residual sum and normalization (Add&Norm) processing element 524, and a feed-forward network (FFN) processing element 526.

The landmark coordinate prediction model 530 of the decoder layer 500 may include a coordinate offset processing element 532 (e.g., a multilayer perceptron (MLLP) processing element and a coordinate determination processing element 534. In this case, the coordinate determination processing element 534 may determine the coordinates of a first landmark predicted by the current decoder layer 500, based on a coordinate offset obtained from the coordinate offset processing element 532 of the current decoder layer 500 and the coordinates of the first landmark obtained from a previous decoder layer.

In an example, a query matrix, a key matrix, and a value matrix of a self-attention processing element of a first decoder layer (i.e., an initial decoder layer) may be the masked initial query matrix Qᵢₙᵢₜ to which position information after masking is embedded, the masked initial query matrix Qᵢₙᵢₜ to which position information after masking is embedded, and the masked initial query matrix Qᵢₙᵢₜ, respectively. A query matrix, a key matrix and a value matrix of a self-attention processing element of another decoder layer may be an output matrix of a transformable attention processing element of a masked previous decoder layer to which position information after masking is embedded, an output matrix of the transformable attention processing element of the masked previous decoder layer to which position information after masking is embedded, and an output matrix of the transformable attention layer of the previous decoder layer after masking, respectively.

In an example, the self-attention processing element 510 may only use a query matrix after masking as input, and more specifically, the self-attention processing element 510 may use the query matrix after masking and position information after masking as input. A query matrix may learn structural dependence between landmarks and may capture poses and expressions at landmark positions.

The self-attention processing element 510 may input QP, QP, and Q as a query matrix, a key matrix, and a value matrix, respectively, to the self-attention processing element 510. In this case, QP=Q+P, and P denotes a trainable position embedding (a position embedding after masking). In the case of the first decoder layer, QP denotes the initial query matrix Qᵢₙᵢₜ after masking to which the position information after masking is embedded, and in the case of another decoder layer, QP denotes the output matrix of the transformable attention processing element of the previous decoder layer after masking to which the position information after masking is embedded. In the first decoder layer, Q denotes the initial query matrix Qᵢₙᵢₜ after masking, and, in another decoder layer, Q denotes the output matrix of the transformable attention processing element of the previous decoder layer after masking. The decoder layer 500 may obtain an output matrix QE through processing by the self-attention processing element 510.

In an example, the decoder layer 500 may obtain the output matrix QE through Equation 2 below.

$${q}_{i}^{E} = {\sum }_{j = 1}^{N} {α}_{ij} {q}_{j} , i = 1 , 2 , … N \qquad Equation 2$$

Here,

$${q}_{i}^{E}$$

denotes an i^{th} row vector of the output matrix QE, aᵢⱼ denotes an attention weight obtained by normalizing an inner product between an i^{th} row vector of a query matrix input to the self-attention processing element and a j^{th} row vector of a key matrix input to the self-attention processing element, and qⱼ denotes a j^{th} row vector of an initial query matrix after masking or an output matrix of a transformable attention processing element of the previous decoder layer after masking.

In addition, N denotes the number (i.e., the sum of the number of landmarks corresponding to each landmark style among a plurality of landmark styles) of landmarks.

Specifically, αᵢⱼ may be obtained through Equation 3 below.

$$α = softmax ( Q \times {K}^{T} / \sqrt{{d}_{k}} ) \qquad Equation 3$$

Here, αᵢⱼ denotes a value of a (i,j)th element of a matrix α, dₖ denotes a row vector dimension of a key matrix, and K^{T} denotes transposes.

In this case, a SoftMax operation may be the prior art, which is as shown in Equation 4 below:

$$Softmax ( {x}_{i} ) = \frac{{e}^{{x}_{i}}}{{\sum }_{j} {e}^{{x}_{j}}} \qquad Equation 4$$

A SoftMax operation normalizes all input values to be between (0,1) and ensures the sum of all outputs is 1. In Equation 4, the denominator represents the sum of exponents of all inputs, and the numerator represents an exponent of a specific value.

For example, by inputting each of a coordinate matrix (an initial landmark coordinate matrix in the case of the first decoder layer) of the first landmark predicted by a landmark coordinate prediction processing element, an output matrix (used as a query matrix) of a self-attention processing element, and a memory feature matrix (used as a value matrix) of the previous decoder layer to a transformable attention processing element of a current decoder layer, an output matrix of a transformable attention processing element may be obtained.

The transformable attention processing element 520 of the decoder layer 500 may obtain an updated feature, i.e., an output matrix of the transformable attention processing element 520, of a landmark, based on an output matrix of the self-attention processing element 510, a memory feature matrix, and a first landmark coordinate matrix predicted by the previous decoder layer. In this case, the initial landmark coordinate matrix may be obtained by fully connecting an initial query matrix. For example, the landmark coordinates and the landmark coordinate matrix may have the same or similar meaning.

In an example, an output matrix QD of the transformable attention processing element 520 may be obtained through Equation 5 below.

$${f}_{i} = {\sum }_{k = 1}^{K} {β}_{ik} {x}_{ik} , i = 1 , … , N \qquad Equation 5$$

Here, fᵢ denotes an updated feature of an i^{th} landmark of the output matrix QD, βᵢₖ denotes an attention weight obtained by performing a full connection operation and a SoftMax operation on a query matrix input to the transformable attention processing element, and xᵢₖ denotes a feature corresponding to k^{th} reference point coordinates in the memory feature matrix, where a position offset between the k^{th} reference point coordinates and i^{th} landmark coordinates of the coordinates of the first landmark predicted by the previous decoder layer after masking is obtained by performing a full connection operation on the query matrix input to the transformable attention processing element, and k is a preset value.

In other words, the coordinates of the k^{th} reference point are obtained by adding a position offset to the coordinates of the i^{th} landmark, and a parameter matrix of full connection is related to k. Specifically, βᵢₖ may be obtained through Equation 6 below.

$${β}_{i} = Softmax ( {W}_{k} {QE}_{i} ) \qquad Equation 6$$

Here, βᵢₖ is a k^{th} element of βᵢ. In this case, QEᵢ denotes an i^{th} C-dimensional row vector of an input query matrix of the transformable attention processing element 520. W_{K} is a matrix of a size K×C, denotes a full connection parameter matrix for performing full connection on QEᵢ, and is a trainable matrix.

As such, in an example, the transformable attention processing element 520, after obtaining an inner product between W_{K} and QEᵢ first, may obtain an attention weight βᵢₖ by normalizing the inner product through a SoftMax operation.

Next, xᵢₖ denotes a feature (e.g., a feature is determined corresponding to coordinates in a value matrix M according to the coordinates obtained) obtained by indexing the coordinates obtained by adding a position offset Δpᵢₖ to an element pᵢ (i.e., the i^{th} landmark coordinates predicted by the previous layer decoder) of a landmark coordinate matrix predicted by the previous decoder layer or the initial landmark coordinates (in the case of the first decoder layer) in the coordinates of the value matrix M.

The position offset Δpᵢₖ denotes a relative offset between an i^{th} landmark position and the position of the k^{th} reference point (whose coordinates are a value with a position offset Δpᵢₖ being added to the coordinates of an i^{th} reference point) among K reference points obtained by fully connecting the input query matrix.

In an example, the position offset Δpᵢₖ may be obtained through Equation 7 below.

$$Δ {p}_{i} = {W}_{K}^{′} {QE}_{i} \qquad Equation 7$$

In equation 7, Δpᵢₖ denotes a k^{th} element of Δpᵢ (k=1, . . . , K), QEᵢ denotes an i^{th} C-dimensional row vector of the input query matrix, W′_{K} is a matrix of a size of 2K×C, denotes a full connection parameter matrix for performing full connection on QEᵢ, and is a trainable matrix, and 2 represents that each position includes two values of horizontal and vertical coordinates.

K denotes the number of reference points required by each landmark, and its value may be preset.

To explain further, an example is provided in which a third element of coordinates predicted by the previous decoder layer as an example and the setting of K=4.

The third element may be coordinates p₃ of a third landmark predicted by the previous decoder layer (when the current decoder layer 500 is the first decoder layer, p₃ denotes the initial coordinates of the third landmark, which may be obtained by fully connecting an initial query matrix Qᵢₙᵢₜ). The transformable attention processing element 520 may obtain Δp₃ by fully connecting QEᵢ based on the set K=4. In this case, Δp₃ may include four elements. The transformable attention processing element 520 may be Δp₃₁, Δp₃₂, Δp₃₃, and Δp₃₄. The coordinates of a first reference point corresponding to x₃₁ may be obtained through p₃+Δp₃₁ and an element that an element x₃₁, i.e., an element that the coordinates of a memory feature matrix is p₃+Δp₃₁, of the memory feature matrix may be determined by using the coordinates. Likewise, the transformable attention processing element 520 may obtain a second reference point, a third reference point, and a fourth reference point corresponding to x₃₂, x₃₃, and x₃₄ through p₃+Δp₃₂, [symbol] p₃+Δp₃₃ and p₃+Δp₃₄. In addition, the device for detecting a landmark in a facial image may determine elements x₃₂, x₃₃, and x₃₄ of the memory feature matrix through the second, third, and fourth reference points corresponding to x₃₂, x₃₃, and x₃₄. Ultimately, the transformable attention processing element 520 may obtain an updated feature f₃ of the third landmark and may obtain an updated feature of another landmark in the same manner. In other words, an output matrix of the transformable attention processing element 520 represents an updated feature of a landmark in the facial image.

As described above, the transformable attention processing element 520 uses QE as a query matrix and the memory feature matrix M as a value matrix. Instead of operating a relationship between each element of QE and M, the transformable attention processing element 520 focuses only on a small group of features (e.g., using only features of K points around the ith landmark when operating the feature of the ith landmark) obtained by sampling M based on a reference point (i.e., the initial landmark coordinate matrix or the landmark coordinate matrix predicted by the previous decoder layer).

For example, after obtaining the output matrix of the transformable attention processing element 520, through the offset processing element 532 (e.g., the MLP processing element) in the landmark coordinate prediction model 530 of the decoder layer 500, it may obtain an offset y_{O} that landmark coordinates predicted by the current decoder layer has with respect to landmark coordinates predicted by the previous decoder layer. In other words, the output matrix QD of the transformable attention processing element 520 may be used as input to the coordinate offset processing element 532, and its output may be y_{O}.

For example, the coordinate offset processing element 532 may be implemented through a three-layer fully connected network having an ReLU activation function. In this case, the first two layers include linear full connection followed by the ReLU activation function, and the last layer may output coordinate offset information (i.e., a coordinate offset) directly through full connection without the ReLU activation function. For example, the coordinate offset processing element 532 of FIG. 5 may output the coordinate offset information by using QD as input. Here, the ReLU activation function may be expressed by Equation 8 below.

$$ReLU ( x ) = max ( 0 , x ) \qquad Equation 8$$

The coordinate determination processing element 534 of the landmark coordinate prediction model 530 may obtain the landmark coordinates by using the obtained y_{O} through Equation 9 below.

$$y = σ ( {y}_{O} + {σ}^{- 1} ( {y}_{R} ) ) \qquad Equation 9$$

Here, y denotes the coordinates of the first landmark predicted by the current decoder layer, y_{R} denotes the coordinates of the first landmark predicted by the previous decoder layer after masking, and Yu denotes an offset of y for y_{R}. In this case, the input of a coordinate offset processing element may be the output matrix of the transformable attention processing element 520.

In this case, a function is the prior art. Specifically, a function may be expressed by Equation 10 below.

$$σ ( x ) = \frac{1}{1 + {e}^{- x}} \qquad Equation 10$$

Lastly, when the decoder layer 500 is a decoder layer positioned last, the predicted coordinates of the first landmark may be determined to be the final predicted coordinates of the first landmark.

To understand the present disclosure more clearly, the description may be provided with a model having three decoder layers as an example.

In this example, the first decoder layer uses the masked initial query matrix Qᵢₙᵢₜ to which the position information after masking is embedded as a query matrix and a key matrix, and the masked initial query matrix Qᵢₙᵢₜ (to which the position information after masking is not embedded) is input to the first decoder layer as a value matrix.

Next, the second decoder layer uses the output matrix QD of the masked first decoder layer to which the position information after masking is embedded as a query matrix and a key matrix, and the output matrix QD of the masked first decoder layer (to which the position information after masking is not embedded) is input to the second decoder layer as a value matrix.

Finally, the third decoder layer uses the output matrix QD of a masked second decoder layer to which the position information after masking is embedded as a query matrix and a key matrix, and the output matrix QD of the masked second decoder layer (to which the position information after masking is not embedded) is input to the third decoder layer as a value matrix.

The first decoder layer may predict landmark coordinates by using the initial landmark coordinate matrix, the second decoder layer may predict landmark coordinates by using the landmark coordinates predicted by the first decoder layer, and the third decoder layer may predict landmark coordinates by using the landmark coordinates predicted by the second decoder layer. However, the above example with a model having three decoder layers is merely an example, and in other examples, the model may have only one decoder layer or may have more decoder layers, and another decoder layer, besides the first decoder layer, may perform similar input and output operations.

For example, the model may be trained by using an L1 norm loss function (representing an absolute value of a difference between a predicted value and an actual value) between the predicted landmark coordinates of a training image sample and the actual landmark coordinates of the training image sample, and a regression loss function used for the training may be expressed by Equation 10 below.

$${L}_{reg} = {\sum }_{l = 0}^{{L}_{d}} ‖ {y}_{1} - \hat{y} ‖ \qquad Equation 10$$

Here, L_{reg} denotes a regression loss, yₗ denotes landmark coordinates of a training image sample predicted by each decoder layer, ŷ denotes actual landmark coordinates of the training image sample, L_{d} denotes the number of decoder layers, and l denotes an index of a decoder layer. In this case, the length of ŷ is N, only some positions are filled with actual landmark coordinates, the remaining positions are set to 0, and y₀ denotes the initial landmark position.

In an example, the method of predicting facial landmark coordinates may train the whole prediction model in an end-to-end manner.

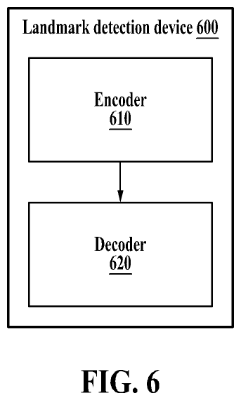

A method of detecting a landmark in a facial image (e.g., method 400) was described above with reference to FIGS. 1 to 5. Hereinafter, a device for detecting a landmark in a facial image according to an embodiment of the present disclosure is described in greater detail below with reference to FIGS. 6, 7, and 8.

FIG. 6 illustrates an example electronic device with landmark coordinate prediction of a facial image according to one or more embodiments.

Referring to FIG. 6, in a non-limiting example, an electronic device 600 for detecting a landmark in a facial image may include an encoder 610 and a decoder 620. In addition, the electronic device 600 may include additional components, and components included in the electronic device 600 for detecting a landmark in a facial image may be divided or combined.

In an example, the encoder 610 may be configured to obtain a multi-level feature map of a facial image through a convolutional neural network layer, obtain an initial query matrix by fully connecting a feature map of a last level of the multi-level feature map through a fully connected layer, and obtain a memory feature matrix by flattening and concatenating the multi-level feature map.

In an example, the decoder 620 may include at least one decoder layer cascaded. In this case, the at least one decoder layer may be configured to determine the coordinates of a first landmark corresponding to at least one landmark style of the facial image, based on a user input to specify at least one landmark style among a plurality of landmark styles, the memory feature matrix, and the initial query matrix.

For example, each decoder layer included in the decoder 620 may include a cascaded mask processing element, a self-attention processing element, a transformable attention processing element, and a landmark coordinate prediction block. In this case, the decoder 620 may obtain a mask matrix corresponding to at least one landmark based on the at least one landmark style among the plurality of landmark styles specified by the user input and may mask a query matrix, a key matrix, and a value matrix that are input to a self-attention model based on the mask matrix to predict the coordinates of the first landmark.

For example, the number of elements in the initial query matrix may be N, in which N represents the sum of the number of landmarks corresponding to each landmark style among the plurality of landmark styles.

The decoder 620, by using a mask model of a first decoder layer based on the mask matrix, may mask the initial query matrix and the position information of the initial query matrix and may set some elements of the initial query matrix and the position information to 0. In this case, the some elements may correspond to landmarks, excluding the first landmark, among landmarks of the plurality of landmark styles.

In addition, the decoder 620, by inputting the initial query matrix after masking to which the position information after masking is embedded, the initial query matrix after masking to which the position information after masking is embedded, and the initial query matrix after masking, respectively as a query matrix, a key matrix, and a value matrix of the self-attention model of the first decoder layer, to a self-attention model of the first decoder layer and inputting an output matrix of a self-attention model of a current decoder layer, the memory feature matrix, and the coordinates of the first landmark predicted by a previous decoder layer after masking to a transformable attention model of the current decoder layer, may obtain an output matrix of the transformable attention model of the current decoder layer. In this case, the output matrix of the transformable attention model of the current decoder layer and the memory feature matrix may be a query matrix and a value matrix of the transformable attention model of the current decoder layer. In addition, the coordinates of the first landmark predicted by the previous decoder layer after masking, which is input to a transformable attention model of the first decoder layer, may be landmark coordinates obtained by masking, based on the mask matrix, initial landmark coordinates obtained based on the initial query matrix. In this case, the coordinates of the first landmark predicted by the previous decoder layer after masking may be obtained by setting some elements of the coordinates of the first landmark predicted by the previous decoder layer based on the mask matrix of the mask model. In this case, the some elements may correspond to landmarks, excluding the first landmark, among landmarks of the plurality of landmark styles.

In addition, the decoder 620, may set some elements (set elements) of the output matrix of the transformable attention model of the current decoder layer and the position information of the output matrix of the transformable attention model of the current decoder layer to 0, by masking the output matrix of the transformable attention model of the current decoder layer and position information corresponding to the output matrix of the transformable attention model of the current decoder layer, based on the mask matrix, by using a mask model of a next decoder layer of the current decoder layer. In this case, the set elements may correspond to landmarks, excluding the first landmark, among landmarks of the plurality of landmark styles.

In addition, the decoder 620, as a value matrix, a query matrix, and a key matrix of a self-attention model of the next decoder layer, may input the output matrix of the transformable attention model of the current decoder layer after masking, the output matrix of the transformable attention model of the current decoder layer after masking to which the position information after masking is embedded, and the output matrix of the transformable attention model of the current decoder layer after masking to which the position information after masking is embedded to the self-attention model of the next decoder layer.

In addition, the decoder 620, may obtain the coordinates of the first landmark predicted by the current decoder layer, by inputting the output matrix of the transformable attention model of the current decoder layer and the coordinates of the first landmark predicted by the previous decoder layer after masking to a landmark coordinate prediction model of the current decoder layer.

In addition, the decoder 620 may set the coordinates of the first landmark predicted by a last decoder layer of the at least one decoder layer to final coordinates of the first landmark.

As described above with respect to FIG. 5, an output matrix QE of a self-attention model of each of the at least one decoder layer may be obtained through Equation 2 below.

$${q}_{i}^{E} = {\sum }_{j = 1}^{N} {α}_{ij} {q}_{j} , i = 1 , 2 , … N \qquad Equation 2$$

For example, as described above, an output matrix QD of a transformable attention model of each of the at least one decoder layer may be obtained through Equation 5 below.

$${f}_{i} = {\sum }_{k = 1}^{K} {β}_{ik} {x}_{ik} , i = 1 , … , N \qquad Equation 5$$

For example, as described above, the coordinates of the first landmark predicted by each of the at least one decoder layer may be obtained through Equation 9 below.

$$y = σ ( {y}_{O} + {σ}^{- 1} ( {y}_{R} ) ) \qquad Equation 9$$

For example, the convolutional neural network layer, the fully connected layer, and the at least one decoder layer may be obtained through training using a training image sample based on the regression loss function, which as described above, may be expressed by Equation 10 below.

$${L}_{reg} = {\sum }_{l = 0}^{{L}_{d}} ‖ {y}_{1} - \hat{y} ‖ \qquad Equation 10$$

For example, the electronic device 600 may include a fully connected layer additionally and may obtain initial coordinates of a landmark in the facial image by fully connecting the initial query matrix through the fully connected layer.

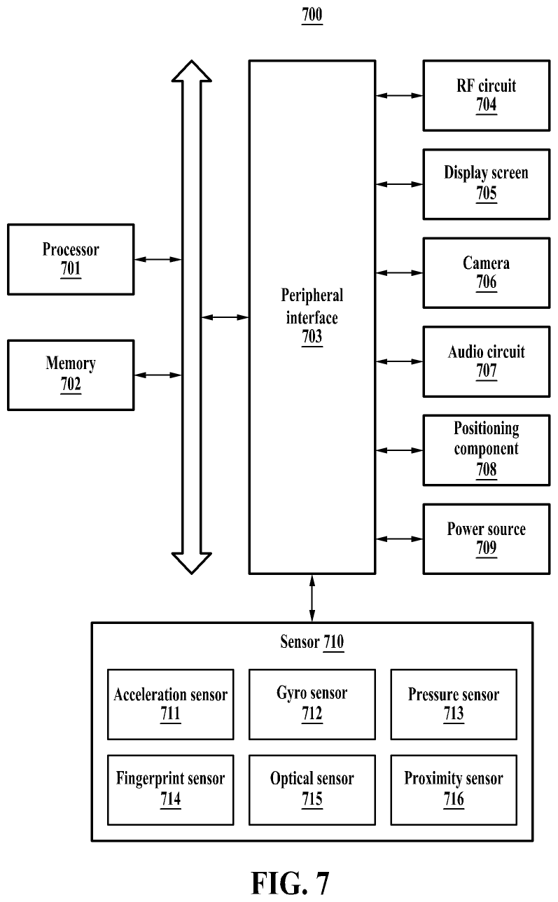

FIG. 7 illustrates an electronic device with landmark coordinate prediction of a facial image according to one or more embodiments.

Referring to FIG. 7, in a non-limiting example, an electronic device 700 may include a processor 701 and a memory 702.

The processor 701 may include one or more processing cores, such as a quad-core processor or an octa-core processor. The processor 701 may be implemented in at least one hardware form among digital signal processing (DSP), a field programmable gate array (FPGA), and a programmable logic array (PLA). In addition, the processor 701 may include a main processor and an auxiliary processor. The main processor may be a processor processing data in an active state, which is also known as a central processing unit (CPU), and the auxiliary processor may be a low-power processor processing data in a standby state. In an example, the processor 701 may be integrated with a graphics processing unit (GPU), and the GPU may be used to render and draw content to be displayed on a display screen. In an example, the processor 701 may also include an artificial intelligence (AI) processor used to process computing tasks related to machine learning.

The memory 702 may include one or more computer-readable storage media, and the computer-readable storage media may be non-transitory. The memory 702 may also include high-speed random-access memory and non-volatile memory, such as one or more disk storage devices and flash memory storage devices. In an example, a non-transitory computer-readable storage medium of the memory 702 may be used to store at least one instruction, and the at least one instruction may be executed by the processor 701 to implement the method of detecting a landmark in a facial image of the present disclosure.

In an example, the electronic device 700 may include a peripheral interface 703 and at least one peripheral device selectively. The processor 701, the memory 702, and the peripheral interface 703 may be connected via a bus or a signal line. Each peripheral device may be connected to the peripheral interface 703 via a bus, a signal line, or a circuit board.

Specifically, a peripheral device may include a radio frequency (RF) circuit 704, a display screen 705, a camera 706, an audio circuit 707, a positioning component 708, and a power source 709.

In an example, the electronic device 700 may include one or more sensors 710 additionally. The one or more sensors 710 may include an acceleration sensor 711, a gyro sensor 712, a pressure sensor 713, a fingerprint sensor 714, an optical sensor 715, and a proximity sensor 716, but are not limited thereto.

However, the example illustrated in FIG. 7 does not limit the electronic device 700, as more or fewer components shown in the drawings may be included, some components may be combined, or a different component arrangement may be used.

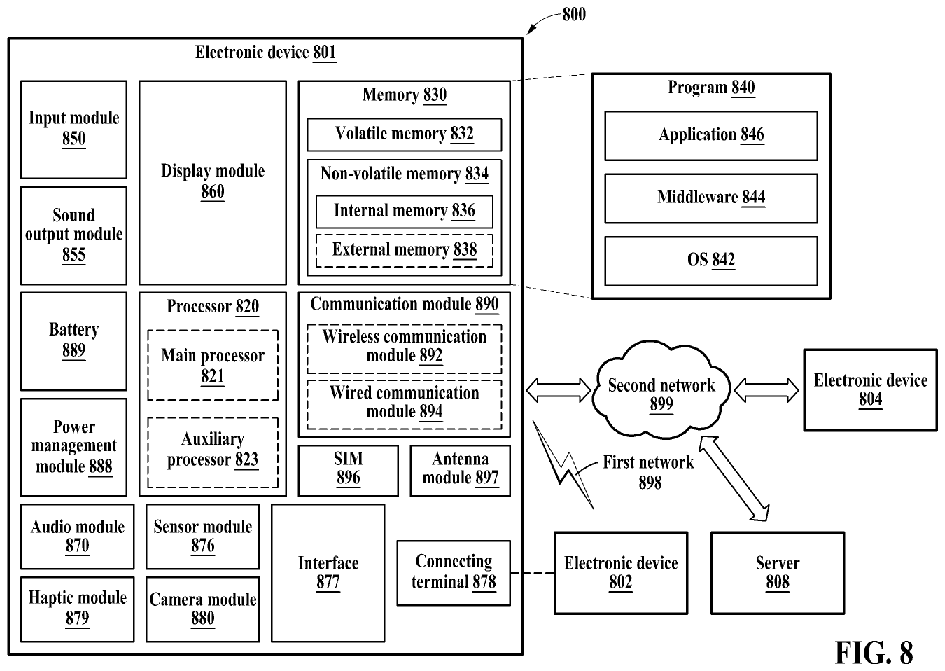

FIG. 8 illustrates an electronic device in a network environment according to one or more embodiment.

Referring to FIG. 8, in a non-limiting example, an electronic device 801 in a network environment 800 may communicate with an electronic device 802 via a first network 898 (e.g., a short-range wireless communication network), or communicate with at least one of an electronic device 804 or a server 808 via a second network 899 (e.g., a long-range wireless communication network). In an example, the electronic device 801 may communicate with the electronic device 804 via the server 808. In an example, the electronic device 801 may include the processor 820, a memory 830, an input module 850, a sound output module 855, a display module 860, an audio module 870, a sensor module 876, an interface 877, a connecting terminal 878, a haptic module 879, a camera module 880, a power management module 888, a battery 889, a communication module 890, a subscriber identification module (SIM) 896, or an antenna module 897. In an example, at least one of the components (e.g., the connecting terminal 878) may be omitted from the electronic device 801, or one or more other components may be added to the electronic device 801. In an example, some of the components (e.g., the sensor module 876, the camera module 880, or the antenna module 897) may be integrated as a single component (e.g., the display module 860).

The processor 820 may execute, for example, software (e.g., a program 840 to control at least one other component (e.g., a hardware or software component) of the electronic device 801 coupled with the processor 820 and may perform various data processing or computation. In an example, as at least a part of data processing or computation, the processor 820 may store a command or data received from another component (e.g., the sensor module 876 or the communication module 890) in a volatile memory 832, process the command or the data stored in the volatile memory 832, and store resulting data in a non-volatile memory 834. In an example, the processor 820 may include the main processor 821 (e.g., a CPU or an application processor (AP)), or an auxiliary processor 823 (e.g., a GPU, an NPU, an image signal processor (ISP), a sensor hub processor, or a communication processor (CP)) that is operable independently from, or in conjunction with the main processor 821. For example, when the electronic device 801 includes the main processor 821 and the auxiliary processor 823, the auxiliary processor 823 may be adapted to consume less power than the main processor 821 or to be specific to a specified function. The auxiliary processor 823 may be implemented separately from the main processor 821 or as a part of the main processor 821.

The processor 820 may control the electronic device 801 of FIG. 8 by executing instructions stored in the memory 830.

The processor 820 may perform the operations of the encoder 610 and the decoder 620 of FIG. 6.

The auxiliary processor 823 may control at least some of functions or states related to at least one (e.g., the display module 860, the sensor module 876, or the communication module 890 of the components of the electronic device 801, instead of the main processor 821 while the main processor 821 is in an inactive (e.g., sleep) state, or together with the main processor 821 while the main processor 821 is an active state (e.g., executing an application). In an example, the auxiliary processor 823 (e.g., an ISP or a CP) may be implemented as a portion of another component (e.g., the camera module 880 or the communication module 890) that is functionally related to the auxiliary processor 823. In an example, the auxiliary processor 823 (e.g., an NPU) may include a hardware structure specified for processing of an AI model. The AI model may be generated by machine learning. Such learning may be performed by, for example, the electronic device 801 in which an AI model is executed, or performed via a separate server (e.g., the server 808).

Learning algorithms may include, but are not limited to, for example, supervised learning, unsupervised learning, semi-supervised learning, or reinforcement learning. The AI model may include a plurality of artificial neural network layers. An artificial neural network may include, for example, a deep neural network (DNN), a convolutional neural network (CNN), a recurrent neural network (RNN), a restricted Boltzmann machine (RBM), a deep belief network (DBN), and a bidirectional recurrent deep neural network (BRDNN), a deep Q-network, or a combination of two or more thereof, but is not limited thereto. The AI model may additionally or alternatively include a software structure other than the hardware structure.

The memory 830 may store various pieces of data used by at least one component (e.g., the processor 820 or the sensor module 876) of the electronic device 801. The various pieces of data may include, for example, software (e.g., the program 840) and input data or output data for a command related thereto. The memory 830 may include the volatile memory 832 or the non-volatile memory 834.

The program 840 may be stored as software in the memory 830, and may include, for example, an operating system (OS) 842, middleware 844, or an application 846.

The input module 850 may receive a command or data to be used by another component (e.g., the processor 820) of the electronic device 801, from the outside (e.g., a user) of the electronic device 801. The input module 850 may include, for example, a microphone, a mouse, a keyboard, a key (e.g., a button), or a digital pen (e.g., a stylus pen).

The sound output module 855 may output a sound signal to the outside of the electronic device 801. The sound output module 855 may include, for example, a speaker or a receiver. The speaker may be used for general purposes, such as playing multimedia or playing record. The receiver may be used to receive an incoming call. In an example, the receiver may be implemented separately from the speaker or as a part of the speaker.

The display module 860 may visually provide information to the outside (e.g., a user) of the electronic device 801. The display module 860 may include, for example, a display, a hologram device, or a projector and control circuitry to control a corresponding one of the display, hologram device, and projector. In an example, the display module 860 may include a touch sensor adapted to sense a touch, or a pressure sensor adapted to measure an intensity of a force incurred by the touch.

The audio module 870 may convert a sound into an electrical signal and vice versa. In an example, the audio module 870 may obtain the sound via the input module 850 or output the sound via the sound output module 855 or an external electronic device (e.g., the electronic device 802 such as a speaker or a headphone) directly or wirelessly connected with the electronic device 801.

The sensor module 876 may detect an operational state (e.g., power or temperature) of the electronic device 801 or an environmental state (e.g., a state of a user) external to the electronic device 801, and then generate an electrical signal or data value corresponding to the detected state. In an example, the sensor module 876 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 877 may support one or more specified protocols to be used for the electronic device 801 to be coupled with the external electronic device (e.g., the electronic device 802) directly (e.g., by wire) or wirelessly. In an example, the interface 877 may include, for example, a high-definition multimedia interface (HDMI), a universal serial bus (USB) interface, a secure digital (SD) card interface, or an audio interface.

The connecting terminal 878 may include a connector via which the electronic device 801 may be physically connected with the external electronic device (e.g., the electronic device 802. In an example, the connecting terminal 878 may include, for example, an HDMI connector, a USB connector, an SD card connector, or an audio connector (e.g., a headphone connector).

The haptic module 879 may convert an electrical signal into a mechanical stimulus (e.g., a vibration or a movement) or an electrical stimulus which may be recognized by a user via his or her tactile sensation or kinesthetic sensation. In an example, the haptic module 879 may include, for example, a motor, a piezoelectric element, or an electric stimulator.

The camera module 880 may capture a still image and moving images. In an example, the camera module 880 may include one or more lenses, image sensors, ISPs, or flashes.

The power management module 888 may manage power supplied to the electronic device 801. In an example, the power management module 888 may be implemented as, for example, at least a part of a power management integrated circuit (PMIC).

The battery 889 may supply power to at least one component of the electronic device 801. In an example, the battery 889 may include, for example, a primary cell which is not rechargeable, a secondary cell which is rechargeable, or a fuel cell.

The communication module 890 may support establishing a direct (e.g., wired) communication channel or a wireless communication channel between the electronic device 801 and the external electronic device (e.g., the electronic device 802, the electronic device 804, or the server 808 and performing communication via the established communication channel. The communication module 890 may include one or more communication processors that operate independently of the processor 820 (e.g., an AP) and support direct (e.g., wired) communication or wireless communication. In an example, the communication module 890 may include a wireless communication module 892 (e.g., a cellular communication module, a short-range wireless communication module, or a global navigation satellite system (GNSS) communication module) or a wired communication module 894 (e.g., a local area network (LAN) communication module, or a power line communication (PLC) module). A corresponding one of these communication modules may communicate with the external electronic device 804 via the first network 898 (e.g., a short-range communication network, such as Bluetooth™, wireless-fidelity (Wi-Fi) direct, or infrared data association (IrDA)) or the second network 899 (e.g., a long-range communication network, such as a legacy cellular network, a 5G network, a next-generation communication network, the Internet, or a computer network (e.g., a LAN or a wide area network (WAN))). These various types of communication modules may be implemented as a single component (e.g., a single chip), or may be implemented as multiple components (e.g., multiple chips) separate from each other. The wireless communication module 892 may identify and authenticate the electronic device 801 in a communication network, such as the first network 898 or the second network 899, using subscriber information (e.g., international mobile subscriber identity (IMSI)) stored in the SIM 896.

The wireless communication module 892 may support a 5G network after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 892 may support a high-frequency band (e.g., a mmWave band) to achieve, e.g., a high data transmission rate. The wireless communication module 892 may support various technologies for securing performance on a high-frequency band, such as, e.g., beamforming, massive multiple-input and multiple-output (massive MIMO), full dimensional MIMO (FD-MIMO), an array antenna, analog beamforming, or a large scale antenna. The wireless communication module 892 may support various requirements specified in the electronic device 801, an external electronic device (e.g., the electronic device 804, or a network system (e.g., the second network 899). In an example, the wireless communication module 892 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 897 may transmit or receive a signal or power to or from the outside (e.g., an external electronic device) of the electronic device 801. In an example, the antenna module 897 may include an antenna including a radiating element including a conductive material or a conductive pattern formed in or on a substrate (e.g., a printed circuit board (PCB)). In an example, the antenna module 897 may include a plurality of antennas (e.g., array antennas). In such a case, at least one antenna appropriate for a communication scheme used in a communication network, such as the first network 898 or the second network 899, may be selected by, for example, the communication module 890 from the plurality of antennas. The signal or the power may be transmitted or received between the communication module 190 and the external electronic device via the at least one selected antenna. In an example, another component (e.g., a radio frequency integrated circuit (RFIC)) other than the radiating element may be additionally formed as part of the antenna module 897.

For example, the antenna module 897 may form a mmWave antenna module. In an example, the mmWave antenna module may include a PCB, an RFIC disposed on a first surface (e.g., a bottom surface) of the PCB or adjacent to the first surface and capable of supporting a specified a high-frequency band (e.g., the mmWave band), and a plurality of antennas (e.g., array antennas) disposed on a second surface (e.g., a top or a side surface) of the PCB, or adjacent to the second surface and capable of transmitting or receiving signals in the specified high-frequency band.

At least some of the above-described components may be coupled mutually and exchange signals (e.g., commands or data) therebetween via an inter-peripheral communication scheme (e.g., a bus, general purpose input and output (GPIO), serial peripheral interface (SPI), or mobile industry processor interface (MIPI)).

In an example, commands or data may be transmitted or received between the electronic device 801 and the external electronic device 804 via the server 808 coupled with the second network 899. Each of the external electronic devices 802 and 804 may be a device of the same type as, or a different type from, the electronic device 801. In an example, all or some of operations to be executed by the electronic device 801 may be executed at one or more external electronic devices (e.g., the external devices 802 and 804, and the server 808). For example, if the electronic device 801 should perform a function or a service automatically, or in response to a request from a user or another device, the electronic device 801, instead of, or in addition to, executing the function or the service, may request the one or more external electronic devices to perform at least part of the function or the service. The one or more external electronic devices receiving the request may perform the at least part of the function or service, or an additional function or an additional service related to the request and may transfer a result of the performance to the electronic device 801. The electronic device 801 may provide the outcome, with or without further processing of the outcome, as at least part of a reply to the request. To that end, cloud computing, distributed computing, mobile edge computing (MEC), or client-server computing technology may be used, for example. The electronic device 801 may provide ultra-low-latency services using, e.g., distributed computing or MEC. In another example, the external electronic device 804 may include an IoT device. The server 808 may be an intelligent server using machine learning and/or a neural network. In an example, the external electronic device 804 or the server 808 may be included in the second network 899. The electronic device 801 may be applied to intelligent services (e.g., smart home, smart city, smart car, or healthcare) based on 5G communication technology or IoT-related technology.

The electronic devices, electronic apparatuses, processors, memories, neural networks, electronic apparatus 200, query matrix initialization processing element 220, backbone network 240, flattening and concatenation processing element 250, decoder 260, cascaded first mask processing element 311, 321, 331, self-attention processing element 313, 323, 333, transformable attention processing element 314, 324, 334, second mask processing element 312, 322, 332, self-attention processing element 510, self-attention processing element 512, residual sum and normalization processing element 514, transformable attention processing element 520, self-attention processing element 522, residual sum and normalization processing element 524, coordinate offset processing element 532 processing element, coordinate determination processing element 534, electronic device 600, encoder 610, decoder 620, electronic device 700, processor 701, memory 702, .3network environment 800, electronic device 801, electronic device 802, electronic device 804, server 808, processor 820, and memory 830 described herein, including descriptions with respect to respect to FIGS. 1-8, are implemented by or representative of hardware components. As described above, or in addition to the descriptions above, examples of hardware components that may be used to perform the operations described in this application where appropriate include controllers, sensors, generators, drivers, memories, comparators, arithmetic logic units, adders, subtractors, multipliers, dividers, integrators, and any other electronic components configured to perform the operations described in this application. In other examples, one or more of the hardware components that perform the operations described in this application are implemented by computing hardware, for example, by one or more processors or computers. A processor or computer may be implemented by one or more processing elements, such as an array of logic gates, a controller and an arithmetic logic unit (ALU), a digital signal processor (DSP), a microcomputer, a programmable logic controller, a field-programmable gate array (FPGA), a programmable logic array (PLU), a microprocessor, or any other device or combination of devices that is configured to respond to and execute instructions (e.g., code or coding) in a defined manner to achieve a desired result. In one example, a processor or computer includes, or is connected to, one or more memories storing the instructions or software that are executed by the processor or computer. Hardware components implemented by a processor or computer may execute the instructions or software, such as an operating system (OS) and one or more software applications that run on the OS, to perform the operations described in this application. The hardware components may also access, manipulate, process, create, and store data in response to execution of the instructions or software. For simplicity, the singular term “processor” or “computer” may be used in the description of the examples described in this application, but in other examples multiple processors or computers may be used, or a processor or computer may include multiple processing elements, or multiple types of processing elements, or both, and thus while some references may be made to a singular processor or computer, such references also are intended to refer to multiple processors or computers. For example, a single hardware component or two or more hardware components may be implemented by a single processor, or two or more processors, or a processor and a controller. One or more hardware components may be implemented by one or more processors, or a processor and a controller, and one or more other hardware components may be implemented by one or more other processors, or another processor and another controller. One or more processors, or a processor and a controller, may implement a single hardware component, or two or more hardware components. As described above, or in addition to the descriptions above, example hardware components may have any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing. Thus, references to a processor herein mean processing circuitry (e.g., circuitry that includes one or more processing element(s) circuits). One or more processors comprising processing circuitry also refers to each processor comprising processing circuitry, as well as some or all of the one or more processors comprising the same processing circuitry. In addition, processors(s) and controller(s), as a non-limiting example, do not mean human processing or human control, but rather, refer to hardware components as described herein, as non-limiting examples.

The methods illustrated in, and discussed with respect to, FIGS. 1-8 that perform the operations described in this application are performed by computing hardware, for example, by one or more processors or computers, implemented as described above implementing the instructions (e.g., computer or processor/processing device readable instructions) or software to perform the operations described in this application that are performed by the methods. For example, a single operation or two or more operations may be performed by a single processor, or two or more processors, or a processor and a controller. One or more operations may be performed by one or more processors, or a processor and a controller, and one or more other operations may be performed by one or more other processors, or another processor and another controller. One or more processors, or a processor and a controller, may perform a single operation, or two or more operations. References to a processor, or one or more processors, as a non-limiting example, configured to perform two or more operations refers to a processor or two or more processors being configured to collectively perform all of the two or more operations, as well as a configuration with the two or more processors respectively performing any corresponding one of the two or more operations (e.g., with a respective one or more processors being configured to perform each of the two or more operations, or any respective combination of one or more processors being configured to perform any respective combination of the two or more operations). Likewise, a reference to a processor-implemented method is a reference to a method that is performed by one or more processors or other processing or computing hardware of a device or system.

The instructions or software to control computing hardware, for example, one or more processors or computers, to implement the hardware components and perform the methods as described above may be written as computer programs, code segments, or other executable instructions or any combination thereof, for individually or collectively instructing or configuring the one or more processors or computers to operate as a machine or special-purpose computer to perform the operations that are performed by the hardware components and the methods as described above. In one example, the instructions or software include machine code that is directly executed by the one or more processors or computers, such as machine code produced by a compiler. In another example, the instructions or software includes higher-level code that is executed by the one or more processors or computer using an interpreter. The instructions or software may be written using any programming language based on the block diagrams and the flow charts illustrated in the drawings and the corresponding descriptions herein, which disclose algorithms for performing the operations that are performed by the hardware components and the methods as described above.

The instructions or software to control computing hardware, for example, one or more processors or computers, to implement the hardware components and perform the methods as described above, and any associated data, data files, and data structures, may be recorded, stored, or fixed in or on one or more non-transitory computer-readable storage media, and thus, not a signal per se. Thus, references herein to storage media mean storage media hardware, and does not mean to transitory media, nor a signal per se. As described above, or in addition to the descriptions above, examples of a non-transitory computer-readable storage medium include one or more of any of read-only memory (ROM), random-access programmable read only memory (PROM), electrically erasable programmable read-only memory (EEPROM), random-access memory (RAM), dynamic random access memory (DRAM), static random access memory (SRAM), flash memory, non-volatile memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-REs, blue-ray or optical disk storage, hard disk drive (HDD), solid state drive (SSD), flash memory, a card type memory such as a multimedia card or a micro card (for example, secure digital (SD) or extreme digital (XD)), magnetic tapes, floppy disks, magneto-optical data storage devices, optical data storage devices, hard disks, solid-state disks, and/or any other device that is configured to store the instructions or software and any associated data, data files, and data structures in a non-transitory manner and provide the instructions or software and any associated data, data files, and data structures to one or more processors or computers so that the one or more processors or computers can execute the instructions. In one example, the instructions or software and any associated data, data files, and data structures are distributed over network-coupled computer systems so that the instructions and software and any associated data, data files, and data structures are stored, accessed, and executed in a distributed fashion by the one or more processors or computers.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

Therefore, in addition to the above and all drawing disclosures, the scope of the disclosure is also inclusive of the claims and their equivalents, i.e., all variations within the scope of the claims and their equivalents are to be construed as being included in the disclosure.

What is claimed is:

1. A processor-implemented method, the method comprising:
obtaining a multi-level feature map of a facial image through a convolutional neural network layer;
generating an initial query matrix by fully connecting a feature map of a last level of the multi-level feature map through a fully connected layer;
generating a memory feature matrix by flattening and concatenating the multi-level feature map; and
determining, based on an input specifying at least one landmark style among a plurality of landmark styles, the memory feature matrix, and the initial query matrix, coordinates of a first landmark corresponding to the at least one landmark style of the facial image by using at least one decoder layer of one or more cascaded decoder layers.

2. The method of claim 1, wherein each of the one or more cascaded decoder layers comprise:
a cascaded mask processing element, a self-attention processing element, a transformable attention processing element, and a landmark coordinate prediction model, and
wherein the determining of the coordinates of the first landmark comprises:
generating, based on the at least one landmark style specified by the input among the plurality of landmark styles, a mask matrix corresponding to the at least one landmark style; and,
masking, based on the mask matrix, a query matrix, a key matrix, and a value matrix being input to the self-attention processing element to predict the coordinates of the first landmark.

3. The method of claim 2, wherein the determining of the coordinates of the first landmark comprises:
masking, based on the mask matrix, the initial query matrix and position information corresponding to the initial query matrix by using a first mask processing element of a first decoder layer and setting a subset of elements of the initial query matrix and the position information to 0;
inputting the initial query matrix after masking to which the position information after masking is embedded to a self-attention processing element of the first decoder layer as a query matrix and a key matrix of the self-attention processing element of the first decoder layer and inputting the initial query matrix after masking to the self-attention processing element of the first decoder layer as a value matrix of the self-attention processing element of the first decoder layer;
generating, by inputting an output matrix of a self-attention processing element of a current decoder layer, the memory feature matrix, and the coordinates of the first landmark predicted by a previous decoder layer after masking to a transformable attention processing element of the current decoder layer, an output matrix of the transformable attention processing element of the current decoder layer;
by masking the output matrix of the transformable attention processing element of the current decoder layer and position information corresponding to the output matrix of the transformable attention processing element of the current decoder layer, based on the mask matrix, by using a mask processing element of a next decoder layer of the current decoder layer, setting a subset of elements of the output matrix of the transformable attention processing element of the current decoder layer and the position information of the output matrix of the transformable attention processing element of the current decoder layer to 0;
inputting, as a value matrix, a query matrix, and a key matrix of a self-attention processing element of the next decoder layer, the output matrix of the transformable attention processing element of the current decoder layer after masking, an output matrix of the transformable attention processing element of the current decoder layer after masking to which the position information after masking is embedded, and an output matrix of the transformable attention processing element of the current decoder layer after masking to which the position information after masking is embedded to the self-attention processing element of the next decoder layer;
generating, by inputting the output matrix of the transformable attention processing element of the current decoder layer and the coordinates of the first landmark predicted by the previous decoder layer after masking to a landmark coordinate prediction processing element of the current decoder layer, the coordinates of the first landmark predicted by the current decoder layer; and
setting the coordinates of the first landmark predicted by a last decoder layer of the one or more cascaded decoder layers to final coordinates of the first landmark.

4. The method of claim 3, wherein a first number of elements of the initial query matrix is a sum of a second number of landmarks corresponding to each landmark style among the plurality of landmark styles.

5. The method of claim 3, wherein the subset of elements correspond to landmarks excluding the first landmark among landmarks corresponding to the plurality of landmark styles.

6. The method of claim 3, wherein the output matrix of the transformable attention processing element of the current decoder layer and the memory feature matrix comprise a query matrix and a value matrix of the transformable attention processing element of the current decoder layer, and
wherein the coordinates of the first landmark predicted by the previous decoder layer after masking, which is input to a transformable attention processing element of the first decoder layer, comprise landmark coordinates obtained by masking, based on the mask matrix, initial landmark coordinates obtained based on the initial query matrix,
wherein the coordinates of the first landmark predicted by the previous decoder layer after masking are obtained by setting a subset of elements of the coordinates of the first landmark predicted by the previous decoder layer based on the mask matrix of the mask processing element.

7. The method of claim 3, wherein an output matrix QE of a self-attention processing element of each of one or more cascaded decoder layers is obtained through an first equation of:
$${q}_{i}^{E} = {\sum }_{j = 1}^{N} {α}_{ij} {q}_{j} , i = 1 , 2 , … N$$
wherein,
$${q}_{i}^{E}$$
denotes an i^{th} row vector of the output matrix QE, aᵢⱼ denotes an attention weight obtained by normalizing an inner product between an i^{th} row vector of a query matrix input to the self-attention processing element and a j^{th} row vector of a key matrix input to the self-attention processing element, and j denotes a j^{th} row vector of an initial query matrix after masking or an output matrix of a transformable attention processing element of the previous decoder layer after masking.

8. The method of claim 3, wherein an output matrix QD of a transformable attention processing element of each of the one or more cascaded decoder layers is obtained through a second equation of:
$${f}_{i} = {\sum }_{k = 1}^{K} {β}_{ik} {x}_{ik} , i = 1 , … , N$$
wherein, fᵢ denotes an updated feature of an i^{th} landmark of the output matrix QD, βᵢₖ denotes an attention weight obtained by performing a full connection operation and a SoftMax operation on a query matrix input to the transformable attention processing element, and xᵢₖ denotes a feature corresponding to k^{th} reference point coordinates in the memory feature matrix,
wherein a position offset between the k^{th} reference point coordinates and i^{th} landmark coordinates of the coordinates of the first landmark predicted by the previous decoder layer after masking is obtained by performing a full connection operation on the query matrix input to the transformable attention processing element, and k is a preset value.

9. The method of claim 3, wherein the coordinates of the first landmark predicted by each of the one or more cascaded decoder layers are obtained through a third equation of:
$$y = σ ( {y}_{O} + {σ}^{- 1} ( {y}_{R} ) )$$
wherein, y denotes the coordinates of the first landmark predicted by the current decoder layer, y_{R} denotes the coordinates of the first landmark predicted by the previous decoder layer after masking, and y_{O} denotes an offset of y for y_{R}.

10. An electronic apparatus, the apparatus comprising:
an encoder, the encoder being configured to obtain a multi-level feature map of a facial image through a convolutional neural network layer, generate an initial query matrix by fully connecting a feature map of a last level of the multi-level feature map through a fully connected layer, and generate a memory feature matrix by flattening and concatenating the multi-level feature map; and
a decoder, the decoder being configured to determine, based on an input specifying at least one landmark style among a plurality of landmark styles, the memory feature matrix, and the initial query matrix, coordinates of a first landmark corresponding to the at least one landmark style of the facial image by using at least one decoder layer of one or more cascaded decoder layers.

11. The apparatus of claim 10, wherein each of the one or more cascaded decoder layers comprise:
a cascaded mask processing element, a self-attention processing element, a transformable attention processing element, and a landmark coordinate prediction model, and
wherein the decoder, based on the at least one landmark style specified by the input among the plurality of landmark styles, is configured to generate a mask matrix corresponding to the at least one landmark, and, to mask, based on the mask matrix, a query matrix, a key matrix, and a value matrix being input to the self-attention processing element to predict the coordinates of the first landmark.

12. The apparatus of claim 11, wherein the decoder is further configured to:
mask, based on the mask matrix, the initial query matrix and position information corresponding to the initial query matrix by using a mask processing element of a first decoder layer and sets a subset of elements of the initial query matrix and the position information to 0;
input the initial query matrix after masking to which the position information after masking is embedded to the self-attention processing element of the first decoder layer as a query matrix and a key matrix of a self-attention processing element of the first decoder layer and inputs the initial query matrix after masking to the self-attention processing element of the first decoder layer as a value matrix of the self-attention processing element of the first decoder layer;
generate, by inputting an output matrix of a self-attention processing element of a current decoder layer, the memory feature matrix, and the coordinates of the first landmark predicted by a previous decoder layer after masking to a transformable attention processing element of the current decoder layer, an output matrix of the transformable attention processing element of the current decoder layer; and
by masking the output matrix of the transformable attention processing element of the current decoder layer and position information corresponding to the output matrix of the transformable attention processing element of the current decoder layer, based on the mask matrix, by using a mask processing element of a next decoder layer of the current decoder layer, a subset of elements of the output matrix of the transformable attention processing element of the current decoder layer and the position information of the output matrix of the transformable attention processing element of the current decoder layer to 0.

13. The apparatus of claim 12, wherein a first number of elements of the initial query matrix is a sum of a second number of landmarks corresponding to each landmark style among the plurality of landmark styles.

14. The apparatus of claim 12, wherein the subset of elements correspond to landmarks excluding the first landmark among landmarks corresponding to the plurality of landmark styles.

15. The apparatus of claim 12, wherein the decoder is further configured to:
input, as a value matrix, a query matrix, and a key matrix of a self-attention processing element of the next decoder layer, the output matrix of the transformable attention processing element of the current decoder layer after masking and an output matrix of the transformable attention processing element of the current decoder layer after masking to which the position information after masking is embedded, and an output matrix of the transformable attention processing element of the current decoder layer after masking to which the position information after masking is embedded to the self-attention processing element of the next decoder layer,
generate, by inputting the output matrix of the transformable attention processing element of the current decoder layer and the coordinates of the first landmark predicted by the previous decoder layer after masking to a landmark coordinate prediction processing element of the current decoder layer, the coordinates of the first landmark predicted by the current decoder layer; and
set the coordinates of the first landmark predicted by a last decoder layer of the one or more cascaded decoder layers to final coordinates of the first landmark.

16. The apparatus of claim 15, wherein the output matrix of the transformable attention processing element of the current decoder layer and the memory feature matrix comprise a query matrix and a value matrix of the transformable attention processing element of the current decoder layer,
wherein the coordinates of the first landmark predicted by the previous decoder layer after masking, which is input to a transformable attention processing element of the first decoder layer, comprise landmark coordinates obtained by masking, based on the mask matrix, initial landmark coordinates obtained based on the initial query matrix, and
wherein the coordinates of the first landmark predicted by the previous decoder layer after masking are obtained by setting a subset of elements of the coordinates of the first landmark predicted by the previous decoder layer based on the mask matrix of the mask processing element.

17. The apparatus of claim 15, wherein an output matrix QE of a self-attention processing element of each of the at least one decoder layer is obtained through a first equation of:
$${q}_{i}^{E} = {\sum }_{j = 1}^{N} {α}_{ij} {q}_{j} , i = 1 , 2 , … N$$
wherein,
$${q}_{i}^{E}$$
denotes an i^{tlh} row vector of the output matrix QE, aᵢⱼ denotes an attention weight obtained by normalizing an inner product between an i^{th} row vector of a query matrix input to the self-attention processing element and a j^{th} row vector of a key matrix input to the self-attention processing element, and qⱼ denotes a j^{th} row vector of an initial query matrix after masking or an output matrix of a transformable attention processing element of the previous decoder layer after masking.

18. The apparatus of claim 15, wherein an output matrix QD of a transformable attention processing element of each of the at least one decoder layer is obtained through a second equation of:
$${f}_{i} = {\sum }_{k = 1}^{K} {β}_{ik} {x}_{ik} , i = 1 , … , N$$
wherein, fᵢ denotes an updated feature of an i^{th} landmark of the output matrix QD, βᵢₖ denotes an attention weight obtained by performing a full connection operation and a SoftMax operation on a query matrix input to the transformable attention processing element, and xᵢₖ denotes a feature corresponding to k^{th} reference point coordinates in the memory feature matrix, and
wherein a position offset between the k^{th} reference point coordinates and i^{th} landmark coordinates of the coordinates of the first landmark predicted by the previous decoder layer after masking is obtained by performing a full connection operation on the query matrix input to the transformable attention processing element, and k is a preset value.

19. The apparatus of claim 15, wherein the coordinates of the first landmark predicted by each of the at least one decoder layer are obtained through a third equation of:
$$y = σ ( {y}_{O} + {σ}^{- 1} ( {y}_{R} ) )$$
wherein, y denotes the coordinates of the first landmark predicted by the current decoder layer, y_{R} denotes the coordinates of the first landmark predicted by the previous decoder layer after masking, and y_{O} denotes an offset of y for y_{R}.

20. An electronic device comprising:
processors configured to execute instructions; and
a memory storing the instructions, wherein execution of the instructions configures the processors to:
obtain a multi-level feature map of a facial image through a convolutional neural network layer,
generate an initial query matrix by fully connecting a feature map of a last level of the multi-level feature map through a fully connected layer,
generate a memory feature matrix by flattening and concatenating the multi-level feature map, and,
determine, based on an input specifying at least one landmark style among a plurality of landmark styles, the memory feature matrix, and the initial query matrix, coordinates of a first landmark corresponding to the at least one landmark style of the facial image by using at least one decoder layer of one or more cascaded decoder layers.
